(19) United States
(12) Patent Application Publication
(10) Pub. No.: US 2016/0146956 A1
(43) Pub. Date: May 26, 2016

(54) Versatile Acoustic Source

(71) Applicant: Schlumberger Technology Corporation, Sugar Land, TX (US)

(72) Inventors: Abderrhamane Ounadjela, Yokohama-shi (JP); Henri-Pierre Valero, Yokohama-shi (JP); Jean-Christophe Auchere, Shibuya-ku (JP)

(21) Appl. No.: 14/936,460

(22) Filed: Nov. 9, 2015

Related U.S. Application Data
(60) Provisional application No. 62/082,566, filed on Nov. 20, 2014.

(51) Int. Cl. G01V 1/135

(52) U.S. Cl. CPC G01V 1/135

(57) ABSTRACT

A technique facilitates acoustic measurement and analysis in a variety of acoustic applications. An acoustic source is provided with a housing, e.g. a cylindrical housing, and a motor located within the housing. A piston is driven by the motor. The acoustic source also is provided with a radiating plate mounted along the housing and exposed to an environment surrounding the housing. A fluid passage contains actuating fluid and extends between the piston and the radiating plate. The piston and the radiating plate are linked by the fluid passage such that reciprocation of the piston by the motor causes oscillation of the radiating plate to create an acoustic signal. In some applications, a plurality of radiating plates and/or a plurality of motors may be arranged to enable monopole, dipole, cross-dipole, and/or quadrupole measurements.

### BACKGROUND

During exploration and analysis of hydrocarbon bearing formations, acoustic systems are utilized to obtain formation data. For example, the generation and recording of acoustic waves through a subterranean formation may be employed during wellbore logging to obtain formation related measurements. The acoustic/sound waves are generated by an acoustic source and are generally classified as longitudinal type waves or transverse type waves. A longitudinal, or compression, wave is one in which the medium which generates the wave oscillates in the same direction as the wave propagates. A transverse, or shear, wave is one in which the medium oscillates perpendicular to the direction of wave propagation. Both types of waves, and the velocities of those waves, are of interest in oilfield applications. The acoustic waves propagate underground at velocities that vary depending on different geological formations. For example, the compression wave travels at about 4000 m/s through sandstone and about 5000 m/s through limestone. A log of sound velocity with depth is used in geophysical inversion. Additionally, the acoustic velocity depends on rock properties, e.g. porosity, stress state, and rock strength, so measurement of the acoustic velocity also is useful in geomechanics applications and petrophysics applications for analysis of the formation.

Acoustic measurements may be made by a sonic logging tool which comprises an acoustic transmitter source and an array of acoustic receivers separated by a known distance. Acoustic energy is radiated from the transmitter source into the borehole medium where it excites multiple waves propagating along the borehole to the receiver array where the wave data is recorded as waveforms. Waves propagating in the borehole environment can be divided into dispersive type waves and non-dispersive type waves. Acoustic dispersion refers to the phenomenon that waveforms slowness (reciprocal of velocity) changes with frequency. Acoustic waves for which the slowness does not change the frequency are referred to as non-dispersive. Both types of waves may be analyzed to obtain data on the corresponding geological formation.

### SUMMARY

In general, a system and methodology are provided to facilitate acoustic measurement and analysis in a variety of acoustic applications. An acoustic source is provided with a housing, e.g. a cylindrical housing, and a motor located within the housing. A piston is driven by the motor. The acoustic source also is provided with a radiating plate exposed to an environment surrounding the housing. A hydraulic passage contains hydraulic fluid and extends between the piston and the radiating plate. The piston and the radiating plate are fluidly linked by the hydraulic passage such that reciprocation of the piston by the motor causes oscillation of the radiating plate to create acoustic signals. In some applications, a plurality of radiating plates and/or a plurality of motors may be arranged to enable monopole, dipole, and/or quadrupole measurements.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of an example of a well system utilizing an acoustic source located downhole, according to an embodiment of the disclosure;

FIG. 2 is an illustration of an example of an acoustic source, according to an embodiment of the disclosure;

FIG. 3 is a schematic illustration of an example of a piston and fluid passage utilized in an acoustic source, according to an embodiment of the disclosure;

FIG. 4 is a schematic illustration of another example of an acoustic source, according to an embodiment of the disclosure;

FIG. 5 is a schematic illustration of an example of a portion of an acoustic source utilizing a seal member, according to an embodiment of the disclosure; and

FIG. 6 is a schematic illustration showing how the acoustic source or sources may be operated as a monopole source, dipole source, or quadrupole source, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The disclosure herein generally involves a system and methodology providing a versatile acoustic source or sources which may be used in a subterranean, e.g. downhole, applications. The technique facilitates acoustic measurement and analysis in a variety of acoustic, data acquisition applications. According to an embodiment, an acoustic source is provided with a housing, e.g. a cylindrical housing. A motor is located within the housing and is able to drive a piston in a reciprocating manner. The acoustic source also is provided with a radiating plate mounted through the housing and exposed to an environment surrounding the housing. A hydraulic passage contains hydraulic fluid and extends between the piston and the radiating plate.

The piston and the radiating plate are linked by the hydraulic passage such that reciprocation of the piston by the motor causes oscillation of the radiating plate to create and transmit an acoustic signal. In some applications, the piston is reciprocated in a direction parallel with the longitudinal axis of the housing and oscillation of the radiating plate is driven in a direction generally transverse, e.g. perpendicular, to the longitudinal axis. Depending on the application, an individual motor may be used in combination with an individual radiating plate; an individual motor may be used in combination with a plurality of radiating plates; or a plurality of motors may be used in combination with a plurality of radiating plates. The radiating plates and motors may be arranged to enable operation of the acoustic source in monopole, dipole, and/or quadrupole modes.

The construction of the acoustic source enables efficient operation and use of at least one acoustic source in a wide range of borehole diameters and in other subterranean environments. The power of the acoustic source may be related to the volume of the motor. For example, embodiments may utilize a high ratio of motor volume relative to the volume of the active source, e.g. radiating plate. In these applications, the motor piston has a larger active surface area acting against the hydraulic fluid compared to the active surface area of the radiating plate.

In various well applications, the acoustic source or sources facilitate acoustic logging of subterranean formations surrounding a borehole. Each acoustic source effectively provides a transducer which efficiently generates large acoustic wave amplitude. The acoustic sources also may be constructed in packages having a small diameter for use in many types of boreholes. In some applications, a plurality of motors may be placed along a major, longitudinal axis of the acoustic source in a manner which allows the acoustic source to generate several acoustic modes of radiation. The acoustic sources also may be used with many types of tools, including wireline and logging-while-drilling tools. In logging-while-drilling applications, the acoustic source or sources take measurements while the well is being drilled to reduce drilling time and rig costs. The logging-while-drilling applications also enable a driller to accurately adjust drilling direction using collected and processed data sent to the surface via appropriate telemetry.

In general, embodiments of the acoustic source enable efficient creation of acoustic signals thus facilitating collection of acoustic measurements in a borehole. The acoustic measurements provide, for example, information related to the velocity of acoustic waves propagating in the formation. The acoustic measurements also may provide information resulting from acoustic signals reflected from features in the formation. As described in greater detail below, the acoustic source is constructed to deliver sufficient power into the desired vibrational modes to obtain a signal-to-noise ratio at the seismic receivers which is suitable for processing. A good signal-to-noise ratio is very useful in high noise environments, such as those environments encountered in logging-while-drilling applications or when there is substantial attenuation from acoustic source to acoustic receiver.

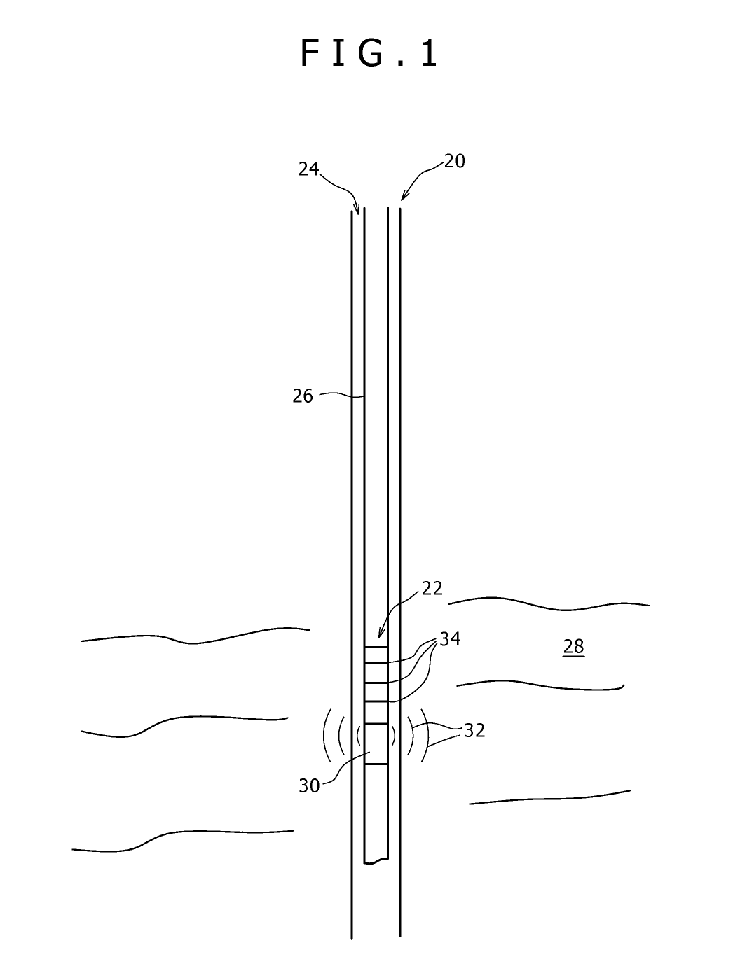

Referring generally to FIG. 1, an embodiment of an acoustic system 20 is illustrated. In this embodiment, the acoustic system 20 comprises an acoustic tool 22 deployed downhole into a borehole 24, e.g. a wellbore. The acoustic tool 22 may be positioned along a well string 26, e.g. a drill string. Depending on the application, the acoustic tool 22 may be used to obtain information on a surrounding geological formation 28 as an independent operation or in combination with other operations, such as drilling operations.

In the illustrated example, the acoustic tool 22 comprises an acoustic source 30 which may be operated to output acoustic signals 32 in the form of waves. The acoustic tool 22 further comprises a receiver or receivers 34, e.g. an array of receivers 34, which are positioned to receive the acoustic signals 32. Thus, the acoustic tool 22 is able to generate acoustic waves 32 and to receive and record those acoustic waves 32 after propagating along the borehole 24 and/or after being reflected back from features of the surrounding geological formation 28.

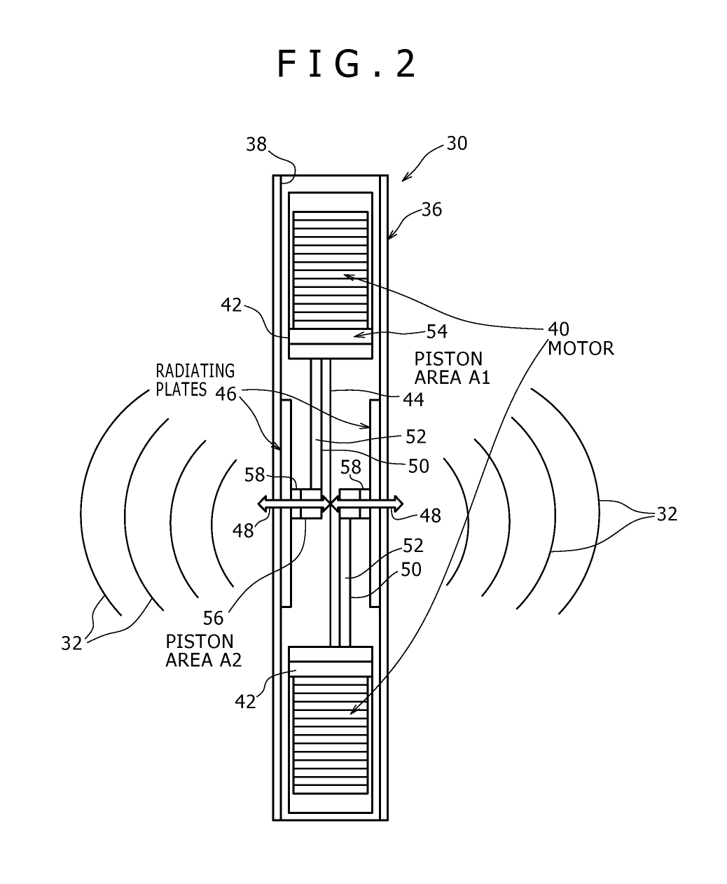

Referring generally to FIG. 2, an embodiment of acoustic source 30 is illustrated. In this embodiment, acoustic source 30 comprises a housing 36 having an interior 38. By way of example, the housing 36 may be in the form of a tubular housing having a generally circular outer diameter. A motor 40 is disposed within the housing 36 and comprises a piston 42 which is driven by the motor 40 with a reciprocal motion. In the example illustrated, a plurality of the motors 40 is disposed within the housing 36, and each motor has a corresponding piston 42 which may be driven with a reciprocal motion in a direction generally parallel with a longitudinal axis 44 of the housing 36. In some applications, the motor 40 comprises a reciprocating motor, e.g. a piezoelectric motor, but other types of motors 40 may be employed to impart the reciprocating motion to piston 42.

The acoustic source 30 further comprises a radiating plate 46 positioned along an outer diameter of the housing 36, e.g. tubular housing, for oscillation in a lateral direction. In the specific example illustrated, a plurality of the radiating plates 46 is arranged along the outer diameter of the housing 36 and the radiating plates 46 are oriented and mounted for oscillation in a lateral direction, as represented by arrows 48, with respect to the longitudinal axis 44. In some applications, the lateral direction is generally perpendicular with respect to the longitudinal axis 44 and with respect to the direction of reciprocal motion of pistons 42. The oscillation of the radiating plates 46 acts against fluid in the borehole 24 and provides acoustic signals in the form of propagating pressure waves.

In the illustrated example, each motor 40 is operatively coupled with a corresponding radiating plate 46 via a fluid passage 50 containing an actuating fluid 52, such as a hydraulic fluid. Various arrangements of motors 40 and radiating plates 46 may be used, but the illustrated example provides a fluid passage 50 between each motor 40 and the individual, corresponding radiating plate 46. In other words, the two illustrated motors 40 are operatively coupled with the two illustrated radiating plates 46 by two dedicated fluid passages 50 which may be sealed therebetween.

Depending on the application, the acoustic source 30 may be constructed to operate in one or more modes, e.g. monopole mode, dipole mode, cross-dipole mode, or quadrupole mode. In the specific example illustrated in FIG. 2, each radiating plate 46 is actuated by one motor 40 via actuating fluid 52 transported through the corresponding fluid passage 50. The dipole mode of radiation may be obtained by driving the motors 40 out of phase, and the monopole mode of radiation may be obtained by driving the motors 40 in phase.

The plurality of fluid passages 50 places the pistons 42 in communication with their corresponding radiating plates 46 so that reciprocation of the pistons 42 causes oscillation of the plurality of radiating plates 46. In this example, the motors 40 are oriented to reciprocate their pistons 42 longitudinally. This longitudinal motion is translated along the actuating fluid 52 in fluid passages 50 to cause transverse, e.g. perpendicular, oscillation at the radiating plates 46. The acoustic source arrangement enables a space efficient package for providing the desired transverse/lateral oscillation which creates and transmits the acoustic signals.

Each piston 42 acts against the actuating fluid 52 via an active surface area 54 and the actuating fluid 52 is moved against a corresponding active surface area 56 of the corresponding radiating plate 46. By way of example, each of the radiating plates 46 may comprise a plate piston 58 which has the active surface area 56 exposed to the actuating fluid 52. The illustrated arrangement of components within the acoustic source 30 accommodates relatively large device diameters as well as relatively small actuator diameters. In various applications, the active surface area 54 of piston 42 is substantially larger, e.g. at least twice the size, compared with the active surface area 56 of the corresponding radiating plate 46.

Regardless of the size of the acoustic source 30, the mechanical source impedance of the motors 40 is properly matched with the acoustic radiation impedance of the radiating plates 46. The desired matching may be achieved by adjusting the size of the pistons 42 versus the size of the corresponding plate pistons 58. Depending on the choice of motor or motors 40, the mechanical impedance output of the pistons 42 may be suitably transformed by selecting appropriate sizes of the pistons 42 and the plate pistons 58. Adjusting the sizes and relative sizes of the pistons 42, 48 effectively changes the active surface areas 54, 56 and this adjustment can be used to improve the efficiency of the acoustic source 30. The size of the fluid passages 50 also can play a role in optimizing the efficiency of the acoustic source 30.

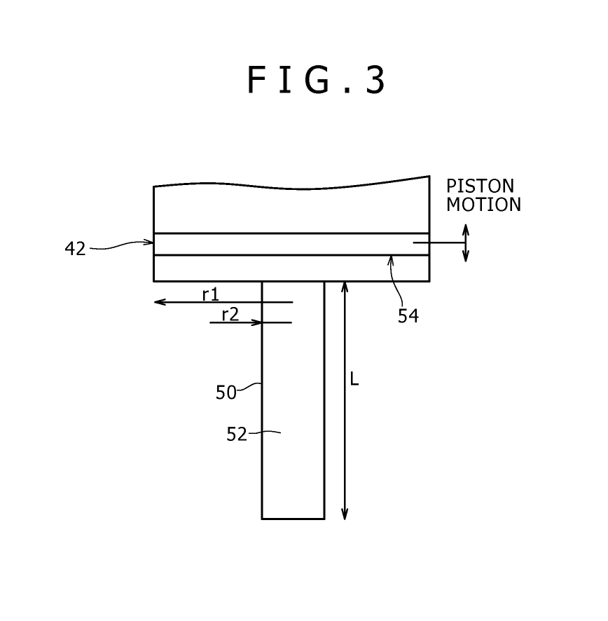

For example, the various relative sizes affect the pressure loss over a frequency bandwidth. To optimize the transfer of energy of motors 40 to corresponding radiating plates 46 via fluid passages 50, models have been developed to predict the pressure loss as a function of the geometrical sizes of the fluid passages 50, e.g. hydraulic conduits, and the operating efficiency. Examples of such models are provided below and explained with reference to the schematic illustration in FIG. 3.

The various models enable optimization of the efficiency of the acoustic source 30 by enabling selection of relative sizes and surface areas that reduce the pressure losses and thus reduce the pressure drop. At first order, the pressure drop is mainly due to the viscous effect in the smaller conduit diameter of the fluid passage 50. This loss can be modeled by the following equation, where ΔP represents the pressure drop along the fluid passage.

$$Δ P = \frac{128 μ L Q ( t )}{π {d}^{4}}$$

In this equation, L is the length of the fluid passage (see FIG. 3), d its diameter, μ the viscosity and Q(t) is the volume rate.

By writing

$$Q ( t ) = \frac{d V ( t )}{d t} ,$$

and considering that the motor generates a harmonic flow rate, the pressure drop along the fluid passage 50 can be written in terms of pulsation ω

$$Δ P = \frac{128 μ L j ω V ( t )}{π {d}^{4}} .$$

This equation enables computing the size of the fluid passage diameter assuming that the viscous effects are predominant versus the inertial effect.

The motor generates a flow rate Q1=πr₁²v₁. Because the flow rate is conservative, πr₁²v₁=πr₂²v₂ with r₁ being the size of motor piston and r₂ being the radius of flow line. Thus,

$${r}_{2} = {( \frac{8 π μ L {r}_{1}^{2}}{Δ P} )}^{1 / 4}$$

In some applications, selected models may take into account the flow occurring in the circuit shown FIG. 3. The inertial effect along the fluid passage, the dissipation of energy due to the viscous fluid, and the loss due to the change in diameter can be taken into account in this type of model.

An embodiment of one model comprises adding the various losses for this particular hydraulic circuit as follows:

δP=Inertial loss+singularity loss+Viscous loss

In this example, the inertia loss is described by the Euler equation:

$$\frac{d P ( x , t )}{d x} = - ρ \frac{d v ( t )}{d t}$$

By integrating this equation along the flow line length:

P(x₂,t)−P(x₁,t)=−ρjωLv(t).

We assume that the first fluid chamber adjacent piston 42 has a large diameter and a small length; so in this portion the loss is mainly due the change in diameter while in the rest of the fluid passage 50, the viscous and inertia effects take place as described in the equation:

$$P ( {x}_{2} , t ) - P ( {x}_{1} , t ) = - ρ j ω L {v}_{2} ( t ) + \frac{ρ {v}_{2}^{2} ( t )}{2} K + \frac{32 μ L {v}_{2} ( t )}{{d}_{2}^{2}}$$

In this example, K is the factor taking into account the singularity effect of the change of diameter. In general, this coefficient is close to 0.5. Numerical calculation shows that the pressure loss is less than a few percent with respect to a pressure generated by, for example, a piezoelectric motor 40 over a frequency bandwidth of 10 KHz.

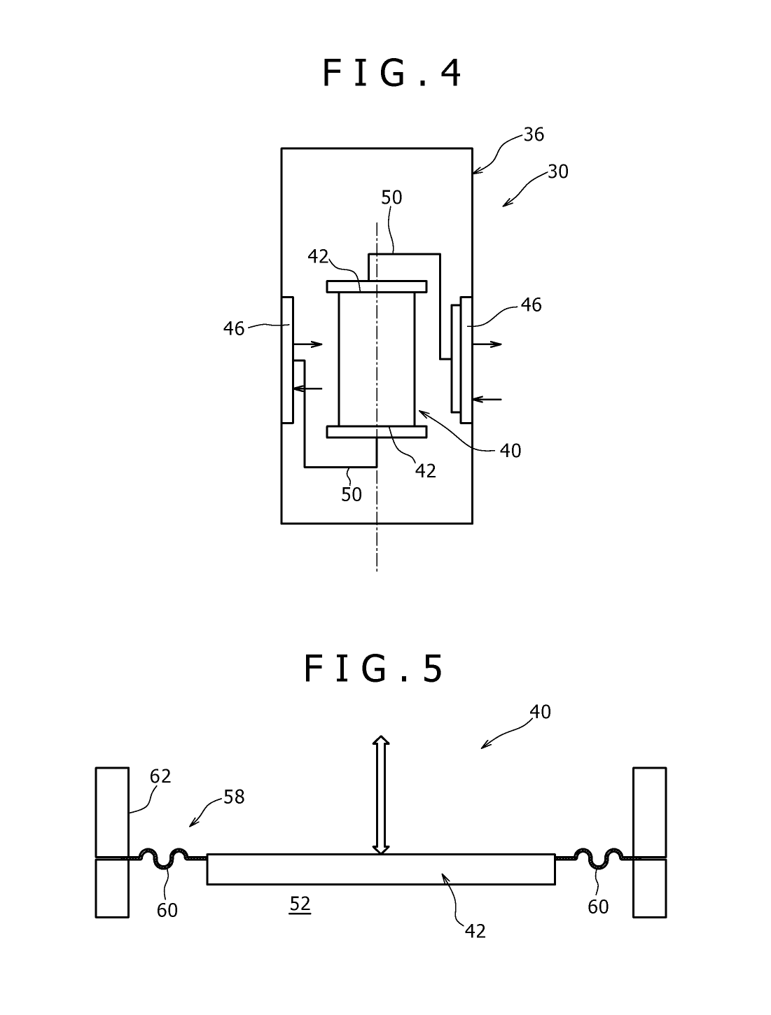

Referring generally to FIG. 4, another embodiment of acoustic source 30 is illustrated. In this example, acoustic source 30 is constructed as a dipole actuator using one motor 40 driving two radiating plates 46. The motor 40 comprises a reciprocating motor, e.g. a piezoelectric motor, which drives opposed pistons 42 in a reciprocating manner. Each piston 42 is coupled with a corresponding one of the radiating plates 46 such that one radiating plate 46 is oscillated in a radially outward direction while the other radiating plate 46 moves in a radially inward direction. The movement of the radiating plates 46 reverses when the motor 40 reciprocates and moves in the opposite direction.

In a variety of borehole applications, the acoustic source or sources 30 may be used in a high pressure and high temperature environment. Accordingly, the acoustic source 30 may be pressure compensated to enable expansion and contraction of the actuating fluid 52, e.g. oil, when subjected to temperature and pressure changes in the harsh wellbore environment. By way of example, an embodiment may employ a pressure compensator or a plurality of pressure compensators which are in fluid communication with the actuating fluid 52 directly or via appropriate compensator passages. The pressure compensators may be formed with pistons, bellows, or other suitable compliant structures. In some applications, fluid contained in the pressure compensators may be separated from the actuating fluid 52 by a separation device which establishes two sealed chambers in the operating frequency range.

Referring generally to FIG. 5, another embodiment is illustrated. According to this embodiment, a structure and technique are provided for sealing and for decoupling each piston 42 by utilizing a sealing member 58. The sealing member 58 is used to effectively seal and decouple each piston 42 with respect to the rest of the acoustic tool 22. By way of example, the sealing member 58 may comprise a membrane 60, such as a corrugated metallic membrane. The membrane 60 is affixed and sealed to the piston 42. The membrane 60 also extends from the piston 42 to a surrounding chamber wall 62 which forms the chamber in which piston 42 reciprocates, thus sealing off the piston 42 and the actuating fluid 52.

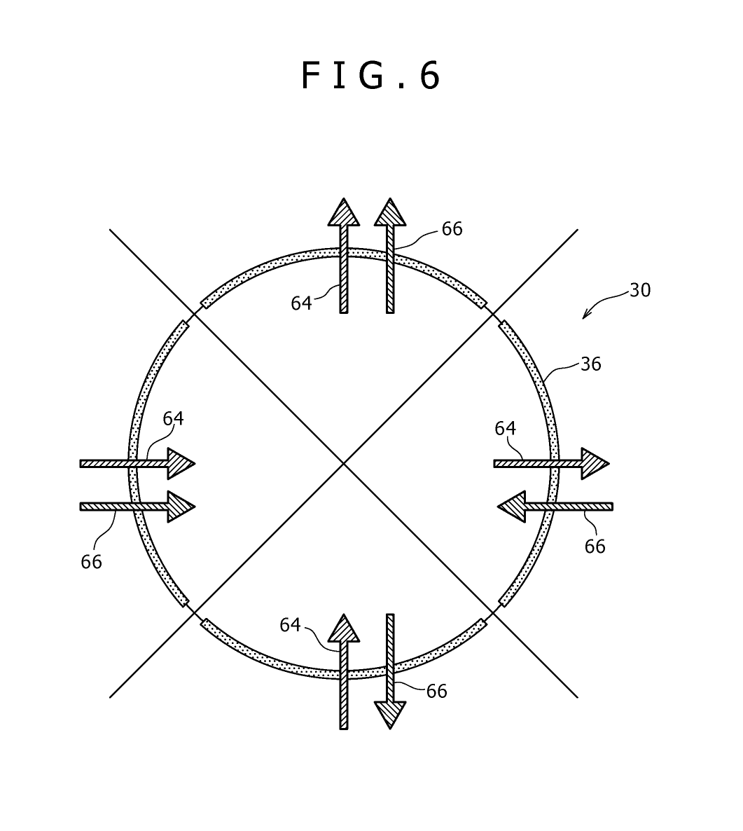

Depending on the application, various numbers of motors 40 and radiating plates 46 may be employed. For example, a single motor 40 or a pair of motors 40 may be used to drive a pair of radiating plates 46 distributed around an azimuth of the acoustic source 30. However, the acoustic source 30 also may comprise four radiating plates 46 or other suitable numbers of radiating plates 46 distributed about the azimuth of the acoustic source 30. The various combinations of motors 40 and radiating plates 46 may be selected to enable operation in a dipole mode, a cross-dipole mode, a monopole mode, a quadrupole mode, or combinations of modes, as illustrated schematically in FIG. 6.

For example, two motors 40 (see FIG. 2) or one motor 40 (see FIG. 4) may be used to actuate the dipole mode represented by arrows 64 in FIG. 6. Additionally, the acoustic source 30 may be operated in a quadrupole mode, as represented by arrows 66. The quadrupole mode may be achieved by, for example, utilizing four motors 40 in combination with four radiating plates 46 distributed around the azimuth of the acoustic source 30. By way of example, the monopole mode may be achieved with a variety of these configurations by operating the radiating plates 46 in phase. In some applications, several acoustic sources 30 can be stacked on each other to enable an increase in the output power or to use the stacked acoustic sources 30 as a transducer array.

Depending on the specifics of a given application, system 20 may comprise many types of components arranged in various configurations. For example, one or more acoustic sources 30 may be disposed at various locations along borehole 24 and/or at other subterranean locations. Similarly, the acoustic tool 22 may comprise numerous types of acoustic receivers 34 positioned downhole with the acoustic source(s) 30 or at a variety of locations separated from the acoustic source. The acoustic source or sources 30 may be used in a dedicated operation or they may be used in combination with other operations, such as drilling operations. Additionally, each acoustic source 30 may comprise a variety of motors, radiating plates, fluid passages, compensation systems, and/or other components assembled to facilitate creation of desired acoustic signals for evaluation of the surrounding formation.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A system for providing an acoustic signal, comprising:
an acoustic source having:
a tubular housing with a longitudinal axis;
a plurality of motors disposed within the tubular housing and having a plurality of pistons, each motor having a corresponding piston oriented for reciprocal motion in a direction generally parallel with the longitudinal axis;
a plurality of radiating plates arranged along an outer diameter of the tubular housing for oscillation in a lateral direction with respect to the longitudinal axis, the oscillation providing acoustic signals; and
a plurality of fluid passages filled with an actuating fluid which places the plurality of pistons in communication with the plurality of radiating plates such that reciprocation of the plurality of pistons causes oscillation of the plurality of radiating plates.

2. The system as recited in claim 1, wherein each motor of the plurality of motors is associated with a corresponding radiating plate of the plurality of radiating plates via a dedicated fluid passage of the plurality of fluid passages.

3. The system as recited in claim 2, wherein each radiating plate is oscillated via a plate piston having a smaller active surface area than the active surface area of the piston of a corresponding motor.

4. The system as recited in claim 1, wherein the plurality of radiating plates oscillates in a direction perpendicular to the direction of reciprocal motion of the plurality of pistons.

5. The system as recited in claim 1, wherein the plurality of pistons is two pistons and the plurality of radiating plates is two radiating plates

6. The system as recited in claim 1, wherein the plurality of motors is operated in a dipole mode.

7. The system as recited in claim 1, wherein the plurality of motors is operated in a monopole mode.

8. The system as recited in claim 1, wherein the plurality of motors is operated in a quadrupole mode.

9. The system as recited in claim 1, wherein pistons of the plurality of pistons are sealed via a membrane.

10. The system as recited in claim 3, wherein the sizes of the plate piston, the piston, and the fluid passage are determined to optimize efficiency of the acoustic source

11. A method for acoustic applications, comprising:
positioning a motor within a housing of an acoustic source such that a piston of the motor is aligned for reciprocation along a longitudinal axis of the housing;
locating a radiating plate along an exterior of the housing for oscillating motion in a direction transverse to the longitudinal axis;
hydraulically coupling the piston with the radiating plate via a hydraulic passage; and
establishing a desired efficiency of the acoustic source by selectively sizing the hydraulic passage and the active impedance areas of the piston and the radiating plate.

12. The method as recited in claim 11, wherein locating comprises orienting the radiating plate to oscillate perpendicularly with respect to the longitudinal axis.

13. The method as recited in claim 11, further comprising creating acoustic signals by operating the motor to reciprocate the piston and to cause a corresponding oscillation of the radiating plate.

14. The method as recited in claim 11, further comprising creating acoustic signals by operating the motor to reciprocate the piston and to cause a corresponding oscillation of a plurality of radiating plates.

15. The method as recited in claim 11, further comprising creating acoustic signals by operating a plurality of the motors to reciprocate a plurality of the pistons and to cause a corresponding oscillation of a plurality of the radiating plates.

16. The method as recited in claim 11, further comprising matching a mechanical source impedance of the piston with an acoustic radiation impedance of the radiating plate.

17. The method as recited in claim 11, wherein positioning comprises positioning a plurality of the motors in the housing, and wherein locating comprises locating a plurality of the radiating plates about an azimuth of the acoustic source.

18. The method as recited in claim 11, wherein positioning comprises positioning at least four of the motors in the housing, and wherein locating comprises locating at least four of the radiating plates about an azimuth of the acoustic source.

19. A system, comprising:
an acoustic source having a housing, a piston driven by a motor located within the housing, a radiating plate mounted to the housing and exposed to an environment surrounding housing, and a hydraulic passage sealed between the piston and the radiating plate, the piston and the radiating plate being linked by the hydraulic passage such that reciprocation of the piston causes oscillation of the reciprocating plate.

20. The system as recited in claim 19, wherein the motor comprises a plurality of motors and the radiating plate comprises a plurality of radiating plates.
